(19) United States
(12) Patent Application Publication
(10) Pub. No.: US 2014/0278655 A1
(43) Pub. Date: Sep. 18, 2014

(54) MODELING SHOPPERS' TIME IN STORES IN RELATION TO THEIR PURCHASES

(71) Applicant: SHOPPER SCIENTIST, LLC, Corbett, OR (US)

(72) Inventor: Herb Sorensen, Corbett, OR (US)

(73) Assignee: Shopper Scientist, LLC, Corbett, OR (US)

(21) Appl. No.: 13/838,614

(22) Filed: Mar. 15, 2013

(51) Int. Cl. G06Q 10/06; G06Q 30/02

(52) U.S. Cl. CPC G06Q 10/063118; G06Q 30/0201
USPC 705/7.17

(57) ABSTRACT

A method for analyzing shopping behavior is provided. The method may comprise, for each of a plurality of a first group of shopper trips, detecting a wireless signal for a shopper proxy device adjacent an entrance and an exit of the store. A shopper trip length may be detected. A first relationship between a number of shopper trips and trip length may be calculated. For each of a plurality of a second group of shopper trips, the method further comprises receiving transaction data for a plurality of purchase transactions. A second relationship between shopper trips and items purchased may be calculated. A third relationship, between items purchased and trip length, based on the first and second relationships may be determined. Additionally, a current number of shoppers may be detected and an in-store service deployed in response to detecting that a current number of shoppers exceeds a first predetermined threshold.

### BACKGROUND

Queue management in retail environments is integral to providing an agreeable shopping experience. Lines or queues for service counters, sales registers, fitting rooms, etc. may grow rapidly as customer volume increases or in response to extensive customer inquiry or purchase volume. Lengthy weight times may result in shopper frustration, anger and ultimately abandonment of intended purchases and loss of revenue.

Methods of tracking customer entry into a retail environment exist but customer volume may not correlate with in-store service needs. For example, many customers may enter a store in a short period of time. However, if only a portion of the customers make purchases or the purchases are of a small number of items, additional in-store service may be unnecessary. In addition, deploying additional employees to sales registers immediately following an influx of shoppers may not be reflective of shopper behavior in a given retail environment as some shoppers may linger in a store for an amount of time before making a purchase.

Further, existing transaction log data may indicate a number or types of items purchased by an individual shopper. Long term analysis of purchase behavior may indicate high grossing products or a tendency towards few item shopping trips for a given retail environment, for example. However, the purchasing habits of a customer base over time may not apply to real time queue management.

### SUMMARY

The inventor herein recognizes the difficulties of managing shopper queues in real time. Long term data collection of shopping trip duration and shopper purchases may be statistically digested to determine probabilistic shopper behavior for a given retail environment.

Disclosed herein are systems and methods for analyzing shopper behavior within a store. A method of the present disclosure may comprise, for each of a plurality of a first group of shopper trips, detecting a wireless signal for a shopper proxy device adjacent an entrance to the store. Furthermore, detecting a wireless signal for the shopper proxy device may occur adjacent an exit of the store. Utilizing proxy device data a trip length for each shopper based on the detected presence of the detected wireless signal at the entrance and the exit of the store may be detected. A first relationship between a number of shopper trips and trip length can thusly be calculated.

For each of a plurality of a second group of shopper trips, the method further comprises receiving transaction data for a plurality of purchase transactions at the store, and transaction data for a plurality of items. Using transaction data, a second relationship between shopper trips and items purchased in the purchase transactions may be calculated. A third relationship, between items purchased and trip length, based on the first and second relationships can be determined.

Additionally, the method of the present disclosure allows for detecting a current number of shoppers in the store and deploying an in-store service in response to detecting that a current number of shoppers exceeds a first predetermined threshold. Deploying an in-store service may comprise deploying an additional service counter attendant, or opening additional registers, as non-limiting examples. In another example, it is further possible to remove the in-store service in response to detecting that the current number of shoppers does not exceed a second predetermined threshold.

Another feature of the present disclosure is the utility of collected data in determining an optimal display configuration for a retail environment. A resultant first relationship from a first configuration of the store may be compared to the first relationship from a second configuration of the store to determine if a peak of the curve has shifted toward an increased trip length. This type of shopping behavior is indicative of shopper trip congruence, where a majority of shoppers traverse a retail environment in a singular, or in some cases multiple, dominant path or paths through a store. Stores with the largest share of shoppers experiencing a medium duration trip length and high trip congruence tend to financially outperform those retail environments where the largest share of shoppers experience short duration trip lengths.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE FIGURES

FIG. 1 shows a schematic depiction of an example shopper detection system.

FIG. 2 shows a schematic depiction of an alternative embodiment of the shopper detection system shown in FIG. 1.

FIG. 3 shows a method for detecting the presence of shoppers in a shopping environment with a second configuration.

FIG. 4 shows an illustration of a statistical graph that correlates the percentage of total shoppers to the number of items a shopper purchased.

FIG. 5 shows an illustration of a statistical graph that correlates the percentage of total shoppers to the minutes those shoppers are in a store.

FIG. 6 shows an illustration of a statistical graph that indicates a correlation between the number of minutes in a store and a number of items purchased.

FIG. 7 shows an illustration of an example temporal relationship between shoppers entering to items purchased and in-store services deployed.

FIG. 8 shows an illustration of a statistical graph that indicates, for each of two example stores, the percentage of shoppers that spend a given number of minutes in each store during a shopping trip.

FIG. 9 shows a flow chart of a method in accordance with the present disclosure.

### DETAILED DESCRIPTION

FIG. 1 shows a schematic depiction of an example shopping environment 1. It will be appreciated that the shopping environment 1 may be, for example, a physical building serving as a retail location in which various products are offered for sale. Example shopping environments include supermarkets, clothing retailers, department stores, hardware stores, restaurants, bazaars, malls, etc.

A system 10 for detecting the presence of shoppers in the shopping environment is provided herein. The system 10 is similar to a tracking system disclosed in in U.S. Provisional application Ser. No. 13/350,461, entitled DETECTING SHOPPER PRESENCE IN A SHOPPING ENVIRONMENT BASED ON SHOPPER EMANATED WIRELESS SIGNALS which is incorporated herein by reference. In the tracking system 10 some of the shoppers 12 that enter shopping environment 1 may possess short range wireless transmission devices 14 on their person. In many circumstances short range wireless transmission devices are paired with other devices to provide wireless communication. For example, a mobile phone and a wireless earpiece may both utilize the BLUETOOTH® standard to wirelessly communicate via short range radio signals. As another example, a portable media player may wirelessly communicate with a wireless pair of headphones via short range radio signals. It will be appreciated that short range wireless transmission devices 14 may be any of the aforementioned or any other short range wireless transmission devices, which emit transmissions with substantially unique characteristics that can be used to distinguish the transmissions of one shopper's device from another. Additional short range wireless transmission devices may also include, but are not limited to include, a universal serial bus (USB) dongle for a portable computing device.

It is commonplace for a shopper to utilize a short range wireless transmission device in shopping environments. For example, a shopper may carry out a conversation on a mobile phone using a hands free Bluetooth® earpiece. This short range radio transmission device may transmit packets of data via 79 bands (1 MHz each) in the range of 2402-2480 MHz in accordance with accepted Bluetooth® standards. Other short range frequencies and protocols may be used for wireless transmission in other embodiments.

The tracking system 10 may include at least one receiver 16 configured to receive wireless signals from the short range wireless transmission devices 14. Receiver 16 may include a controller, such as an application specific integrated circuit, processor, etc., and associated memory. The controller may be configured to implement a wireless detection module to receive and process signals from transmission devices 14 via an antenna 20. The antenna may be a unidirectional antenna or a directional antenna (e.g., “cantenna”), configured to receive signals from transmitters in a monitored area of interest. The wireless detection module may be configured to utilize a BLUETOOTH® stack to interpret signals according to the BLUETOOTH® standard. The wireless detection data may further be configured to store detection data indicating the detected presence of the wireless transmissions from the transmission devices 14 in the associated memory.

The controller may further be configured to implement a network communications module that is configured to communicate via a network interface and associated WIFI antenna or network port with the data analyzer 22, to send the detection data to the data analyzer over a wired or wireless network connection, respectively, for downstream processing. In addition or in the alternative, the receiver may be configured as a USB device, and thus may include USB logic executed by the controller, as well as a USB interface and port that are used to communicate the detection data to the analyzer 22.

It will be appreciated that receiver 16 may be positioned within the shopping environment or may be positioned at a remote location external to the shopping environment. In one example, the antenna may be focused on an entrance/exit 18 location in the shopping environment. In this manner the receiver 16 can receive signals from the entrance/exit 18. It follows that the receiver 16 may determine the number of shoppers having a short range wireless transmission device that enter and exit the shopping environment via the entrance/exit 18. In this way, tracking a wireless proxy device indicates movements of a portion of shoppers and calibration of the tracking method (described herein below) may be used to determine a share of shoppers trackable by wireless proxy and in turn to determine overall numbers of shoppers entering and exiting a retail environment. In many stores, the ratio of all customers to the number of transaction logs is between 1.2 and 1.8, and the ratio of all customers to customers with active wireless devices that are trackable is 12:1 to 20:1.

Suitable mounting locations for receiver 16 within the shopping environment may include, but are not limited to include, a wall, an entrance, an exit, an aisle, etc. In one example, the receiver 16 may be integrated into a cover plate of an electrical outlet, and in another example the receiver may include an integrated power plug that plugs into a power outlet. The receiver 16 may be configured to draw power from the electrical outlet. In this way, the receiver 16 may be inconspicuously placed in the shopping environment 1. The receiver 16 may also be configured to avoid interference with the operation of the electrical outlet, such that the outlet may provide power to other devices. In another example, the receiver may be battery operated, and include an on-board battery supply. Furthermore, receivers 16 may be alternatively or additionally be arranged in varied locations throughout the store. For example, receives 16 may be placed at a check-out register. In this example, an elapsed time from entrance to check out may be calculated for each trackable shopper, in addition to, or alternative to, a time from entrance to exiting the store for that shopper. Additional example locations of receivers 16 may include service counters, product displays or shopper amenity locations.

Returning to FIG. 1, additionally, the receiver 16 may include a global positioning satellite (GPS) unit that enables locating the receiver via a spaced based global navigation system, which may facilitate more extensive statistical analysis of shoppers' behaviors. For example, such GPS enabled receivers 16 may be deployed in stores across the country and may also be configured with the ability to log in to computer networks, for example via a wireless (e.g., WIFI) or wired (e.g. power line communication) network connection, and transmit reports to a central server that include data gathered for each receiver, as well as the GPS-detected location for each receiver. In this manner, large numbers of such receivers may be efficiently managed. Further, the receiver 16 may include a power adapter and associated power plug fitted coupled to a housing of the receiver. In this manner, the receiver 16 to be installed in and powered by a power outlet in the shopping environment 1.

Upon initial installation of the receiver 16, the receiver may be calibrated to ensure its accuracy according to the following process. Video cameras may be installed in the monitored shopping areas and video images may be recorded of shoppers traveling through the monitored area. Technicians may count the actual number of shoppers entering and exiting the monitored area based in the video images, and may compare this to the number of shoppers emanating wireless signals that were counted by the receiver 16. A calibration factor is computed which relates the number of actual shoppers to the number of shoppers detected by receivers 16 during the calibration period. After calibration, this factor is used to compute an estimated number of total shoppers during an observation period based on the number of shoppers detected via receiver 16. As one example, it is estimated that 5-8% of the total shoppers are carrying an active Bluetooth device, and thus if there are N detected shoppers, it may be determined that there are 12*N to 20*N actual shoppers.

Further, to ensure data integrity and eliminate errors, a minimum trip length and a maximum trip length are established, and detected trip lengths for a given shopper that fall below the minimum trip length or exceed the maximum trip length will be ignored when computing shopper trip statistics, such as total trip time for each shopper and average trip time for all shoppers. This helps avoid anomalies that may otherwise erroneously skew the data.

As discussed above, the tracking system 10 may further include a data analyzer 22. The data analyzer 22 may include a memory 24 executable by a processor 26, and may be configured to receive detection data from the one or more receivers, as described above. It will be appreciated that the data analyzer 22 may be positioned at a remote location external to the shopping environment 1, such as at the central server described above. In other embodiments the data analyzer 22 may be positioned within the shopping environment. Data analyzer 22 may be in wired and/or wireless communication with receiver 16. Specifically, the data analyzer 22 may receive detection data from each of the short range wireless transmission devices 14 within the shopping environment 1. The data analyzer 22 may be configured to determine statistical data from the detection data it receives.

Data analyzer 22 may be configured to determine the number of shoppers having a short range wireless transmission device entering and exiting the shopping environment. The data analyzer 22 may also determine if a shopper having a short range wireless transmission device is entering and/or exiting the shopping environment from a direction vector associated with the short range wireless transmission device. In some embodiments the data analyzer 22 may uniquely identify each short range wireless transmission device. In other embodiments unique identification may not be utilized. A counting module in the data analyzer 22 may be configured to determine the total number of shoppers in the shopping environment based on the number of shoppers having a short range wireless transmission device. More specifically, an average ratio of shoppers having short range wireless transmission devices to a total number of shoppers may be used to determine the total number of shoppers in the shopping environment. It will be appreciated that this data may be gathered for each shopping environment via survey, visual observation, etc., or may be gathered from a plurality of shopping environments.

A receiver 16 may be positioned adjacent to an entrance/exit of the shopping environment to determine the number of shoppers entering and exiting the shopping environment. If the receiver 16 includes a directional antenna, the antenna may be positioned to receive short range wireless signals travelling through an entrance/exit of the shopping environment. It will be appreciated that other suitable methods may be used to determine the number of shoppers having a short range wireless transmission device in the shopping environment.

Data analyzer 22 may also be configured to determine the total time a shopper having a short range wireless transmission device spends in the shopping environment. More specifically, the data analyzer 22 may determine when a short range wireless transmission device enters the shopping environment and may record a unique identifier associated with the device. In the BLUETOOTH® implementation, the unique identifier is MAC address of the BLUETOOTH® device. The data analyzer 22 may then start a timer for the device and stop the timer when the device (with the same unique identifier) is determined to have left the shopping environment. It will be appreciated that the length of a shopper's stay within the shopping environment may be useful in marketing analysis.

The data analyzer 22 may also be configured to determine a metric that equals the number of shoppers having a short range wireless transmission device multiplied by the time (e.g., seconds, minutes) these shoppers spend in the shopping environment. This metric may be referred to as shopper seconds. It has been found through statistical analysis that the probability of a shopper being positioned at a location is directly correlated to shopper seconds. For example, 5 shoppers in a given area for 10 minutes yields the same number of shopper seconds as 10 shoppers in the area for 5 minutes. Thus, determining the number of short range wireless transmission devices in the shopping environment along with the time these shoppers spend in the shopping environment may be used to measure the distribution of shopper seconds in the shopping environment.

Communication between the data analyzer 22 and the receiver 16 may be encrypted to prevent unwanted parties from accessing information contained therein. The communication may be implemented over a virtual private network (VPN) or the Internet. Data analyzer 22 may utilize a suitable operating system such as Linux, Windows, Mac Operating System (OS), etc. It will be appreciated that there may be a variety of intermediary devices that may facilitate the connection between the data analyzer 22 and receiver 16. For example, a routing device (not shown) positioned within or adjacent to the shopping environment may be configured to receive signals (e.g., wired/wireless) from receiver 16. The routing device may further be configured to relay the signals over a network (e.g., VPN) to data analyzer 22. The functionality of the data analyzer 22 may also be distributed among multiple computing devices in other embodiments. For example, a wireless tracking computing device (not shown) may be communicatively linked (e.g., wired and/or wireless) to receiver 16. In some cases the wireless tracking computing device may be located within or adjacent to the shopping environment. The wireless tracking computing device may be configured to determine various tracking data corresponding to the short range wireless transmission devices in the shopping environment. The wireless tracking computing device may also be communicatively linked to the data analyzer 22. In this manner, a portion of the data analyzer's functionality may be assigned to other computing devices.

FIG. 2 shows another embodiment of tracking system 10, in a shopping environment 1 with a first configuration of shelving, products, movable displays, etc. Receivers 16 are placed adjacent the left and right entrance/exits 18, and configured to detect signals from wireless devices that are carried by some shoppers as they travel through a monitored area near the entrance/exit. In this way the entering and exiting of a shopper may be tracked by the wherein the paths by which shoppers traverse the store may not be tracked.

The left entrance/exit 18 features a pair of receivers to cover the entire area of ingress and egress, while the right entrance/exit features only one receiver. In combination, data from these receivers monitoring this pair of entrances/exits can be used to detect shopper presence in each monitored area, and to determine, for each shopper, a total amount of time spent in shopping environment 1.

In FIG. 2 a first configuration of shelves 6 and tables 5 is shown. In one example, the shelves 6 may be linear movable displays featuring end caps on a short side. In alternate shopping environments movable displays may also comprise square or round shelving, racks, tables, hangers, etc. The shelves 6 and tables of FIG. 2 hold products 4 for display throughout a shopping environment 1.

Point of sale (POS) registers 30 are shown located at an entrance/exit side of the shopping environment. The registers 30 are equipped with transaction loggers 28 which may log transaction data including the type and number of items purchased per transaction. This transaction log (herein also referred to as T-log) data may be compiled and analyzed by analyzer 22. Analyzer 22 may analyze T-log or tracking system 10 data in real time.

Data analyzer 22 may use real time data acquisition and analysis to, for example, deploy and in-store service in response to detecting that a current number of shoppers exceeds a first predetermined threshold. An indication to deploy an in-store service may be given at alert device 34 which may comprise and audio or visual indication to deploy such a service. Furthermore, alert device 34 may be configured to display a signal to remove the in-store service in response to detecting that the current number of shoppers does not exceed a second predetermined threshold.

In one, non-limiting example, deploying an in-store service may comprise opening additional registers. In an alternative example, deploying an in-store service may occur following a predetermined time after detecting the current number of shoppers exceeds a first predetermined threshold. In this example, it may be detected that a certain number of shoppers have entered a shopping environment. Previous data or experience may indicate that an average shopper spends a certain amount of time in the store before making a purchase. Additional employees may be deployed to registers following a delay after a number of shoppers has entered the store to minimize wait times as those shoppers are queuing up to purchase their items.

In an alternate example, deploying an in-store service may comprise deploying an additional service counter attendant. For example, additional employees may be deployed to a deli, meat, bakery, or other grocery counter, or to a display area, cosmetics counter, fitting room, etc. Furthermore, real time data acquisition and analysis may involve removing the in-store service in response to detecting that the current number of shoppers does not exceed a second predetermined threshold. In this example, it may be detected that a certain number of shoppers has left shopping environment and in that scenario additional employees may not be beneficial at a point of sale, or providing another in-store service.

Turning now to FIG. 3, a second configuration of shopping environment 1 is shown. Movable displays comprising shelves 6 or tables 5 for displaying products 4 have been moved throughout the store. An alternate configuration of the shopping environment may be better suited to direct shopper traffic in a predetermined path for example. In a configuration, such as that shown in FIG. 3 shoppers may be ushered by an arrangement of displays to enter a central area of the store where products 4 are displayed on short tables 5. Such a configuration may allow a shopper to see products in a centralized store location but also to see those on higher shelves 6 located toward a periphery of a store. In this way the generalized path any given shopper takes through a store may more closely resemble an average path.

Stores with higher shopper congruence as far as a standard path taken in a shopping environment tend to experience higher overall sales. Furthermore, these stores tend to have a highest portion of shoppers experiencing a medium trip length duration. The method of the present disclosure may be used to compare trip length duration for differing store configurations, which will be described below in greater detail with reference to FIG. 8.

FIG. 4 shows an illustration of a graph depicting exemplary statistical data that may be generated via tracking system 10 discussed above. Shown is an embodiment of a first relationship that may be calculated in accordance with a method of the present disclosure. More specifically, FIG. 4 correlates the percentage of total shoppers (the “Share of Shoppers”) to the minutes those shoppers are in a shopping environment. It will be appreciated that other statistical data may be generated via tracking system 10 based on the detected presence of shoppers in the monitored areas.

Further, other suitable observation periods may be established, such as over a month, and the system may track, for each unique shopper, multiple visits to the monitored shopping area (store/department) over the observation period. An aggregate visit count and trip time may be calculated over the entire period for each shopper. Further, for all shoppers during the observation period, statistical measures such as average trip length may be computed.

Turning now to FIG. 5, an illustration of a graph depicting exemplary statistical data that may be generated via transaction loggers 28 and data analyzer 22. FIG. 5 shows an example embodiment of a second relationship that may be calculated in accordance with a method of the present disclosure. The graph correlates the percentage of total shoppers (the “Share of Shoppers”) to the number of items those shoppers purchased. It will be appreciated that other statistical data may be generated via transaction logs. The graph of FIG. 5 shows a strong tendency toward more shoppers making few item purchases. This type of correlation is seen in many types of retail environments.

In reference to FIG. 6, the statistical data collected by tracking system 10 and transaction loggers 28 may be combined to provide a third relationship between a time in store and the number of items purchased. FIG. 6 indicates the mode of a number of minutes in store for shoppers purchasing a given number of items. As seen in FIG. 6, a best-fit line indicates a positive correlation between the time a shopper spends in a shopping environment and the number of items they purchase.

This data may be used to determine the statistical shopping behavior of shoppers in a given store setting. Further, extrapolations of the data may include, for example, an average number of items purchased and the average time a shopper takes to purchased said items. Practically, this data may be used to improve a shopping experience, and ultimately, revenue by determining a probabilistic time from a group of shoppers entering a retail environment until they will enter a service counter, or register queue. Furthermore, the number of items a shopper may be statistically expected to purchase will aid in estimates of a number or type of in-store service to deploy in response to sensing an influx of shoppers into the shopping environment.

An example of the above described situation is shown in FIG. 7, which illustrates an example, temporal relationship between shoppers entering a store as detected by the wireless detection methods described above and items purchased as detected via the transaction logs generated at check out registers. On the same axis is shown the deployment of an in-store service to compensate for the increase in items purchased. This in-store service may be an attendant to a register, for example. In the present example, an in-store service is deployed, or removed in a step-wise fashion to comply with increased or decreased demand as it occurs, and is timed to be deployed after the triggering event of an increase in shoppers entering the store is detected, and before the resulting items purchased peak occurs. The precise timing may be predicted based on analysis of past data showing the average time difference that results between an increase in shoppers and an increase in items purchased at checkout. In the FIG. 7, it should be appreciated that number of items purchased, shoppers entering, and services deployed are not on the same vertical scale and the example graph is merely provided as a comparative timeline.

Deployment of the in-store service may be made based on relationships derived from previously collected data as described above. In an alternative embodiment, real-time tracking of wireless proxy devices, and/or transaction log data may be used to deploy to in-store services. In an example scenario tracking system 10 may detect that the number of shoppers in a retail environment has surpassed a predefined threshold. Alert device 34 may be triggered to indicate deployment of additional attendants to a service counter for example. Furthermore, as transaction log data from transaction loggers 28 may indicate items purchased have surpassed a predetermined threshold and an indication to deploy additional attendants to a check-out register may be given. Variations to detection and deployment methods are possible and the above scenario is provided as a non-limiting example.

In reference to FIG. 8, a comparison between a shopping behavior between two store configurations, or two separate stores is graphed. The graph of FIG. 8 shows the same type of data as described above in reference to FIG. 4, in that the percentage of total shoppers (the “Share of Shoppers”) is compared to the minutes those shoppers are in a shopping environment. However, in this graph data from two different store layouts is shown. Store A has a peak-like shape where the largest share of shoppers experiences a middle length duration in store. Whereas store B has a more ski hill like shape where increased time in store is correlated with a decreasing share of shoppers.

Retail environments with a peak-like items-purchased to minutes-in-store relationship such as that seen in Store B tend toward higher trip congruence among shoppers travelling through the store. Trip congruence is indicative of a majority of shoppers traversing a store by a dominant path. In most cases, a store will have a single dominant path; however, in some cases a store may include multiple dominant paths. Trip congruence may be influenced by a store layout such as shelving arranged in a serpentine fashion such as to direct customers in a single given path from entrance to check out, and ultimately to the exit. Furthermore, trip congruence may be influenced by visual stimuli, product placement, spatial awareness or other traffic flow influencing features. For example, a single entrance of a store may enter into a bazaar type area where commonly purchased items are available and readily visible and towards a periphery are specialty items. A specialty item may be something a shopper would make a specific trip for and will seek out, for example. In this type of setting a dominant path typically results, whereby shoppers enter at an entrance and circumnavigate a centralized area, with a smaller share of shoppers diverging into different areas of a retail environment away from the dominant path.

A possible advantage of increasing trip congruence is that shoppers may be physically or subconsciously escorted through a shopping environment in a manner that enables the shopper to orient themselves to their shopping environment more efficiently, which in turn causes the shopper to select and purchase items in a more efficient manner, that is, in less time per item purchased and less time per dollar spent. The inventor of the present application believes that over a very large sample size of shoppers and shopping environments, the relationship between the share of shoppers and the items purchased depicted in FIG. 5 tends towards a log-normal distribution. In most shopping trips a small number of items are purchased. For example, a shopper will pick up a gallon of milk on their way home from work, thus making a single item shopping trip. As a number of items purchased increases, so does a time in store. In many cases, in path divergent retail settings (i.e., with low trip congruence), increased numbers of items purchased is paired with increased inefficiency of spending, resulting in lower spending per unit time by shoppers. With greater path congruence may come greater shopping efficiency, allowing shoppers to make their purchases in an efficient manner and increase the spending per unit of shopping time, thereby increasing sales volumes. Stores with more efficient shopping tend to have higher volumes and higher gross margins.

This type of comparison data is valuable in retail environments as it enables a retailer to track changes in shopping behavior. Alterations to the duration of time customers spend in a store can be compared before and after an alteration to a shopping environment floor plan, for example. Additional comparisons could be drawn between alterations to product selection or arrangement, a type of, or number of, in-store services offered, or a type of display used as non-limiting examples. Furthermore, this data may be used to determine if shoppers are tending towards trip congruence, which is valuable when trying to increase the shopping efficiency of the store, as discussed above.

The particular graph of FIG. 8 displays a first relationship from the first configuration of the store compared to the first relationship from a second configuration of the store. This data can be used to determine if a peak of the curve has shifted toward an increased trip length. Shopping environments where the largest share of shoppers are those shoppers who spend a middle length duration in store tend to be higher grossing retail environments.

These high-grossing retail environments also tend toward a layout where shoppers are ushered towards a singular general path throughout the retail environment. For example, these stores may have a main entrance leading into a centralized bazaar area with lower-lying displays featuring high sales items. Additional, products may be featured toward the periphery of the store on higher displays, visible and easily accessible from the central gallery of the shopping environment. Further, non-limiting methods of promoting trip congruence may include introducing visual stimuli to encourage a dominant path, promoting traffic flow and influencing shopper path by congestion of space, altering store lighting schemes, or arranging shelving to both display products and effectively direct traffic by acting as a barricade to would-be paths.

In accordance with an example method of the present disclosure data from tracking system 10 may be used to, to track a time in store for shoppers after a layout has been changed from that of the shopping environment seen in FIG. 2, to that seen in FIG. 3. A shift towards a longer duration in store, such as that from Store A to Store B of FIG. 8 may be indicative of a positive shift in shopping behavior that may result in higher, overall sales numbers and an indication to maintain an altered layout.

Turning now to FIG. 9, the process flow of an example method 800 in accordance with the present disclosure is diagrammed. The method begins and proceeds to 802 where a wireless signal for a shopper proxy device adjacent an entrance and an exit of the store is detected. The wireless proxy may comprise a BLUETOOTH® signal, and the receiver for the wireless signal may be configured to identify a MAC address of the mobile transmitter, which is substantially unique. The paths by which shoppers traverse the store may not be tracked.

The method proceeds to 804 where a trip length for each of the shoppers based on the detected presence of the wireless signal at the entrance and the exit of the store is detected. The presence of the wireless signal may be detected by tracking system 10 shown in FIGS. 1-3. Trip length data may be collect from a first group of shoppers

The method proceeds to 806, where a first relationship between a number of shopper trips and trip length for each of a plurality of a second group of shopper trips may be calculated. Data analyzer 22 may receive tracking data from tracking system 10 to determine said relationship. An example of a graphical representation of the first relationship is shown in FIG. 4. Furthermore, a first relationship may be compared from a first configuration of a store, to the first relationship from a second configuration of the store to determine if a peak of the curve has shifted toward an increased trip length. An example of such a comparison is shown in FIG. 8.

At 808, transaction data for a plurality of purchase transactions at the store, and transaction data for a plurality of items may be received. Transaction data may be collected by transaction loggers 28. Transaction data may be collected from a second group of shoppers which may differ from a first group of shoppers for which trip length data may be collected.

The method proceeds to 810 where a second relationship between shopper trips and items purchased in the purchase transactions is calculated. An example graphical depiction of the second relationship is shown in FIG. 5.

At 812, the first relationship calculated in step 806 and the second relationship calculated at 801 are used to determine a third relationship between items purchased and a trip length. An example graphical depiction of the third relationship is shown in FIG. 6. The data inherent in the third relationship may be used in determining probabilistic shopper behavior as discussed above.

At 814, a current number of shoppers in the store is detected. This detection may be based on a tracking system 10 as described above or by another suitable method. A number of shoppers in the store takes into account a number of shoppers that have entered and a number of shoppers that have exited the store.

At 816, an in-store service is deployed in response to detecting that a current number of shoppers exceeds a first predetermined threshold. This predetermined threshold may be determined in response to previous data acquired in a given shopping environment indicating a number above which additional attendants at counters or registers may improve an overall shopping experience or minimize wait times or queue length. Similarly, an in-store service may be removed in response to detecting that the current number of shoppers does not exceed a second predetermined threshold. Additionally, previously collected data, such as that from the third relationship shown in FIG. 6 may be used to determine additional features of probabilistic shopping behavior and used, for example, to determine a time after a number of shoppers exceeds a first predetermined threshold before an in-store service may be deployed to most effectively serve a group of shoppers.

The example method as depicted in FIG. 9 then ends. However, additional method variants are possible. For example, the steps 802-812 may be repeated for a second configuration or layout of a store to determine if alterations to shopper behavior have occurred in response to a different physical environment. Furthermore, additional methods of acquiring, displaying or analyzing shopper data are conceivable and the provided examples should not be viewed as limiting.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

1. A system for analyzing shopper behavior within a store, the system comprising:
a sensor system configured to: for each of a plurality of a first group of shopper trips,
detect a wireless signal for a shopper proxy device adjacent an entrance to the store;
detect a wireless signal for the shopper proxy device adjacent an exit of the store;
a data analyzer computing device configured to:
determine a trip length for each shopper based on the detected presence of the detected wireless signal at the entrance and the exit of the store;
calculate a first relationship between a number of shopper trips and trip length; for each of a plurality of a second group of shopper trips,
receive transaction data for a plurality of purchase transactions at the store, and transaction data for a plurality of items;
calculate a second relationship between shopper trips and items purchased in the purchase transactions;
determine a third relationship between items purchased and trip length based on the first and second relationships;
a sensor system configured to:
detect a current number of shoppers in the store; and
an alert device to signal for deploying an in-store service in response to detecting that a current number of shoppers exceeds a first predetermined threshold.

2. The system of claim 1, wherein deploying an in-store service comprises opening additional registers.

3. The system of claim 1, wherein the alert device is further configured to signal for removing the in-store service in response to detecting that the current number of shoppers does not exceed a second predetermined threshold.

4. The system of claim 1, wherein deploying an in-store service occurs following a predetermined time after detecting the current number of shoppers exceeds a first predetermined threshold.

5. The system of claim 1, wherein deploying an in-store service comprises deploying an additional service counter attendant.

6. The system of claim 1, further comprising:
for a first configuration of the store,
a sensor system configured to: for each of a plurality of a first group of shopper trips,
detect a wireless signal for a shopper proxy device adjacent an entrance to the store;
detect a wireless signal for the shopper proxy device adjacent an exit of the store;
a data analyzer computing device configured to:
determine a trip length for each shopper based on the detected presence of the detected wireless signal at the entrance and the exit of the store;
calculate a first relationship between a number of shopper trips and trip length; for each of a plurality of a second group of shopper trips,
receive transaction data for a plurality of purchase transactions at the store, and transaction data for a plurality of items;
calculate a second relationship between shopper trips and items purchased in the purchase transactions;
determine a third relationship between items purchased and trip length based on the first and second relationships;
compare the resultant first relationship from the first configuration of the store, to the first relationship from a second configuration of the store; and
determine if a peak of the curve has shifted toward an increased trip length.

7. The system of claim 1, wherein the wireless signal is a BLUETOOTH® signal, and the receiver is configured to identify a MAC address of the mobile transmitter, which is substantially unique.

8. The system of claim 1, wherein the first group and the second group of shopper trips are different.

9. The system of claim 1, wherein the paths by which shoppers traverse the store are not tracked.

10. A method for analyzing shopper behavior within a store, the method comprising:
for each of a plurality of a first group of shopper trips,
detecting a wireless signal for a shopper proxy device adjacent an entrance to the store;
detecting a wireless signal for the shopper proxy device adjacent an exit of the store;
detecting a trip length for each shopper based on the detected presence of the detected wireless signal at the entrance and the exit of the store;
calculating a first relationship between a number of shopper trips and trip length;
for each of a plurality of a second group of shopper trips,
receiving transaction data for a plurality of purchase transactions at the store, and transaction data for a plurality of items;
calculating a second relationship between shopper trips and items purchased in the purchase transactions;
determining a third relationship between items purchased and trip length based on the first and second relationships;
detecting a current number of shoppers in the store; and
deploying an in-store service in response to detecting that a current number of shoppers exceeds a first predetermined threshold.

11. The method of claim 1, wherein deploying an in-store service comprises opening additional registers.

12. The method of claim 1, further comprising removing the in-store service in response to detecting that the current number of shoppers does not exceed a second predetermined threshold.

13. The method of claim 1, wherein deploying an in-store service occurs following a predetermined time after detecting the current number of shoppers exceeds a first predetermined threshold.

14. The method of claim 1, wherein deploying an in-store service comprises deploying an additional service counter attendant.

15. The method of claim 1, further comprising:
for a first configuration of the store, for each of a plurality of a first group of shopper trips,
detecting a wireless signal for a shopper proxy device adjacent an entrance to the store;
detecting a wireless signal for the shopper proxy device adjacent an exit of the store;
detecting a trip length for each shopper based on the detected presence of the detected wireless signal at the entrance and the exit of the store;
calculating a first relationship between a number of shopper trips and trip length;
for each of a plurality of a second group of shopper trips,
receiving transaction data for a plurality of purchase transactions at the store, and transaction data for a plurality of items;
calculating a second relationship between shopper trips and items purchased in the purchase transactions;
determining a third relationship between items purchased and trip length based on the first and second relationships; and
comparing the resultant first relationship from the first configuration of the store, to the first relationship from a second configuration of the store to determine if a peak of the curve has shifted toward an increased trip length.

16. The method of claim 1, wherein the wireless signal is a BLUETOOTH® signal, and the receiver is configured to identify a MAC address of the mobile transmitter, which is substantially unique.

17. The method of claim 1, wherein the first group and the second group of shopper trips are different.

18. The method of claim 1, wherein the paths by which shoppers traverse the store are not tracked.

19. The method of claim 1, wherein the first configuration of the store differs from the second configuration of the store in a physical location of movable displays and products.

20. A method of managing a queue length in a store comprising:
detecting a trip length for each shopper based on a detected presence of a detected wireless signal at the entrance and the exit of the store;
receiving transaction data for a plurality of purchase transactions at the store, and transaction data for a plurality of items;
determining a probabilistic shopping behavior for the store based on the detected trip length and received transaction data; and
deploying an in-store service responsive to a current number of shoppers in the store exceeding a predetermined threshold and the probabilistic shopping behavior for the store.
